(19) United States
(12) Patent Application Publication
(10) Pub. No.: US 2004/0193765 A1
(43) Pub. Date: Sep. 30, 2004

(54) PDA docking bay module with peripheral integration

(76) Inventors: Yung-chang Hsiao, Cupertino, CA (US); Michael Weizer, Fremont, CA (US)

Correspondence Address: Michael Weizer, 44951 Industrial Dr., Fremont, CA, 94538, US

(21) Appl. No.: 10/401,804

(22) Filed: Mar. 31, 2003

(51) Int. Cl. G06F 13/12

(52) U.S. Cl. 710/72

(57) ABSTRACT

A PDA docking bay module with peripheral integration configured to the size of a conventional floppy drive, which allows it to be installed inside a standard drive bay of a desktop computer.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK

Not Applicable

### APPENDIX

Not Applicable

### BACKGROUND OF THE INVENTION

This invention relates to handheld computing devices, such as personal digital assistants (PDA's), computer peripherals and desktop computers. More specifically it pertains to the techniques for integrating a PDA docking bay module and such devices as a USB hub and flash memory card reader with a desktop computer

A conventional Personal Digital Assistant (PDA) cradle, USB hub and a flash memory card reader are three separate items, and they connect and communicate to a computers external I/O port through its own I/O port. Each one of these devices I/O port is separately connected to a dedicate I/O port on a computer by its own device cable, such as an USB device cable. Through this cable the device transmits and receives signals to and from the computer. Often the PDA cradle, USB hub or flash memory card reader requires its own power source, such as a power adapter plugged into a 120V AC outlet. The large number of cables used in this common computer configuration adds to the complexity of setting up multiple external peripherals and organizing a computer's workspace. Additionally, the limited number of I/O ports on a computer restricts the number of peripheral devices that can be connected to it. This restriction often inhibits computers users from adding additional peripherals.

### BRIEF SUMMARY OF THE INVENTION

This new invention combines the PDA cradle, USB hub and flash memory card reader into a single module and it is sized to be stationed inside a desktop computer.

### BRIEF SUMMARY OF DRAWINGS

FIG. 1 represents how the present invention is integrated to fit inside a drive bay of a desktop computer.

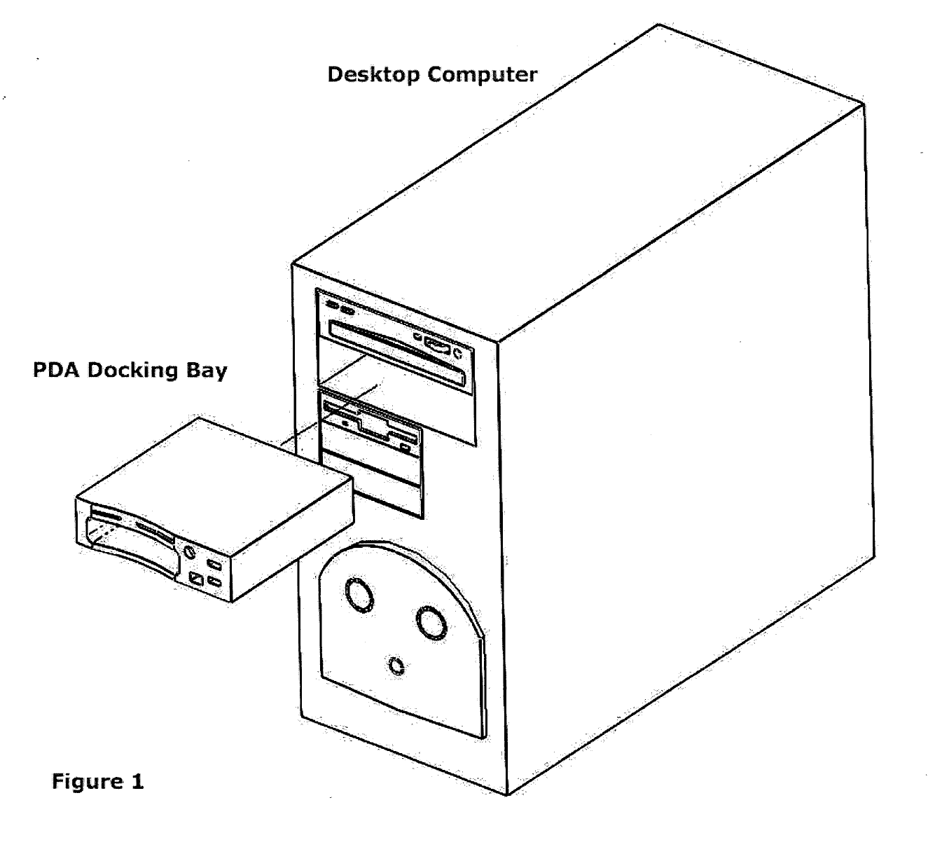

FIG. 2 illustrates how the PDA Docking Bay module receives the PDA for docking.

FIG. 3 illustrates how the PDA Docking Bay module acts as a hub by receiving a USB connector.

FIG. 4 illustrates how the PDA Docking Bay module acts as a Smart Media memory card reader by accepting a Smart Media memory card.

FIG. 5 illustrates how the PDA Docking Bay module acts as a Compact Flash memory card reader by accepting a Compact Flash memory card.

FIG. 6 illustrates how the PDA Docking Bay module acts to receive an infrared (IrDA) signal transmitted from a PDA.

### DETAILED DESCRIPTION OF THE INVENTION

The size of the PDA docking bay module with peripheral integration allows it to be easily fitted into an existing drive bay of a desktop computer. It can facilitate data communication between a PDA and the host computer and a Compact Flash Card or a Smart Memory Card and the host computer. The PDA docking bay module also serves as a hub, providing additional USB ports and includes an infrared (IrDA) port for detached communication with the PDA.

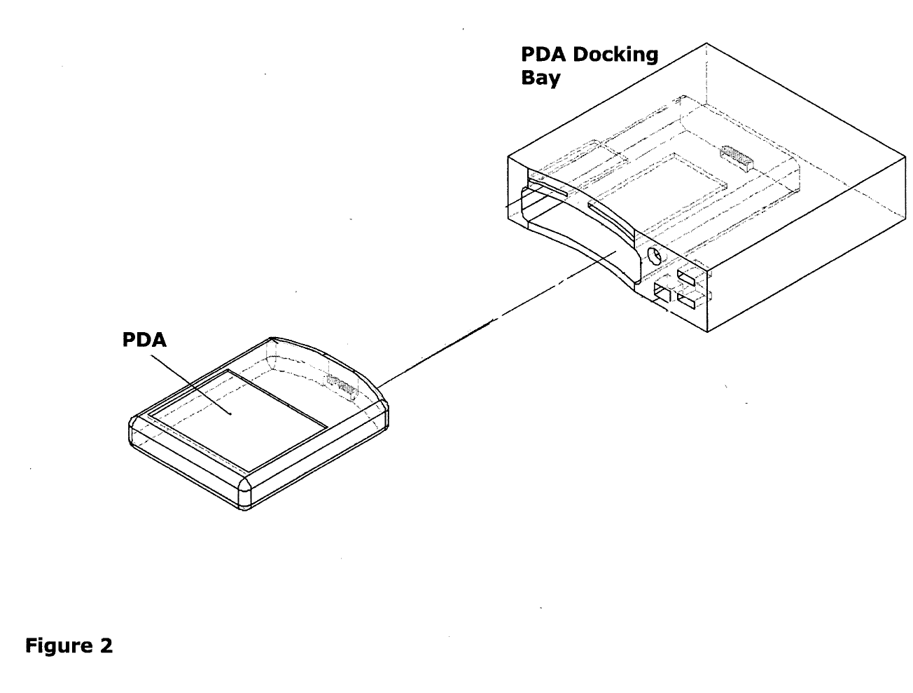

To operate the PDA docking module, insert the PDA into the designed slot (see FIG. 2). The host computer will detect the presence of the PDA and automatically launch its interface software. The PDA docking module will begin charging the batteries of the PDA.

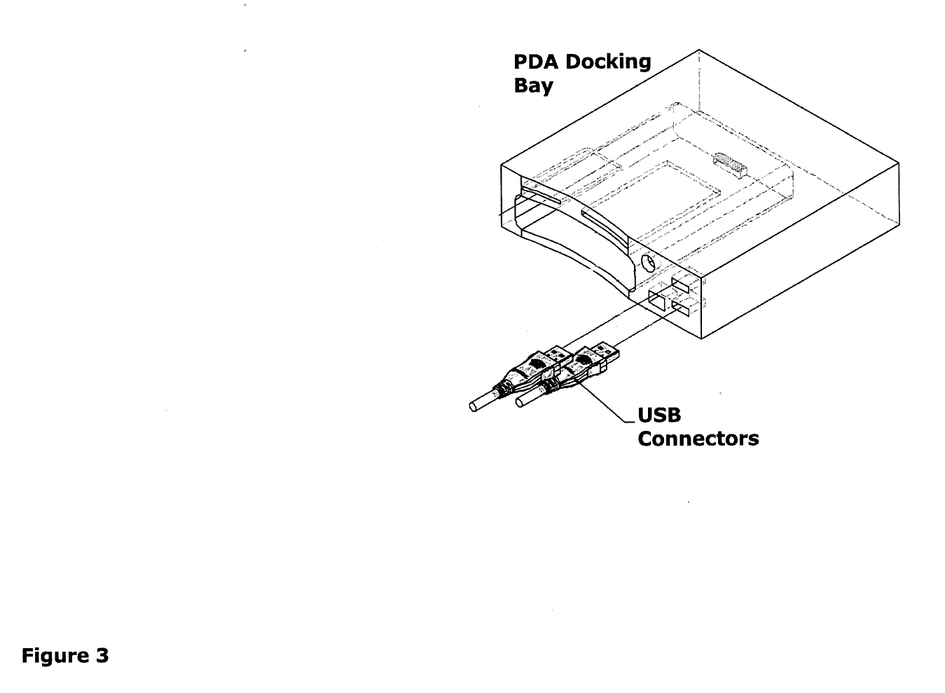

To operate the PDA docking modules integrated USB ports; insert the USB connector of a USB ready peripheral into the designed slot (see FIG. 3). The host computer will detect the presence of a USB ready peripheral.

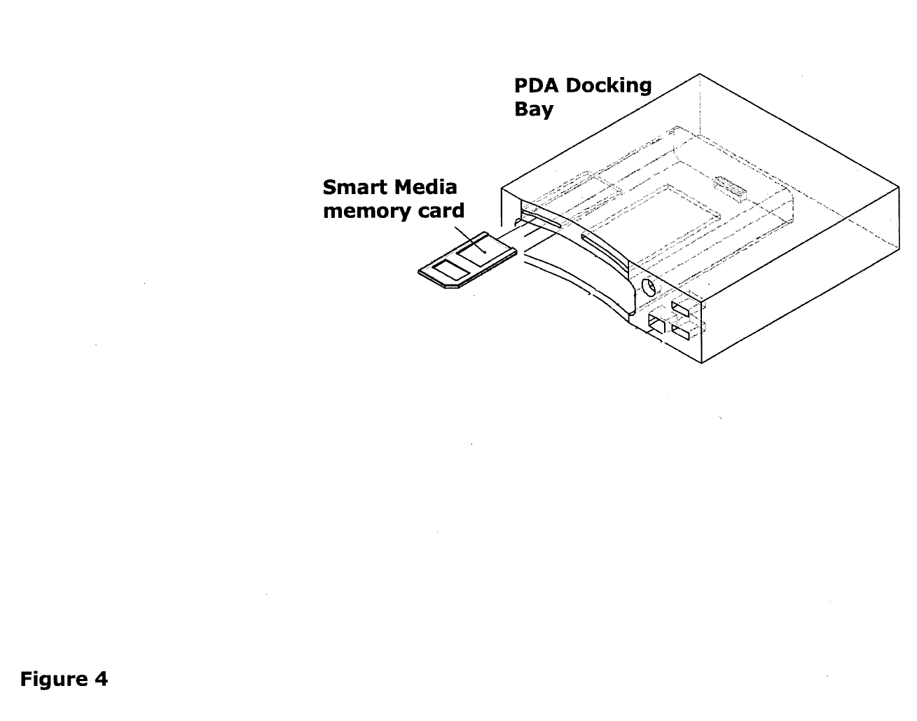

To operate the PDA docking modules integrated Smart Media Card Reader; insert the Smart Media Card into the designed slot (see FIG. 4). The host computer will detect the presence of the Smart Media Card.

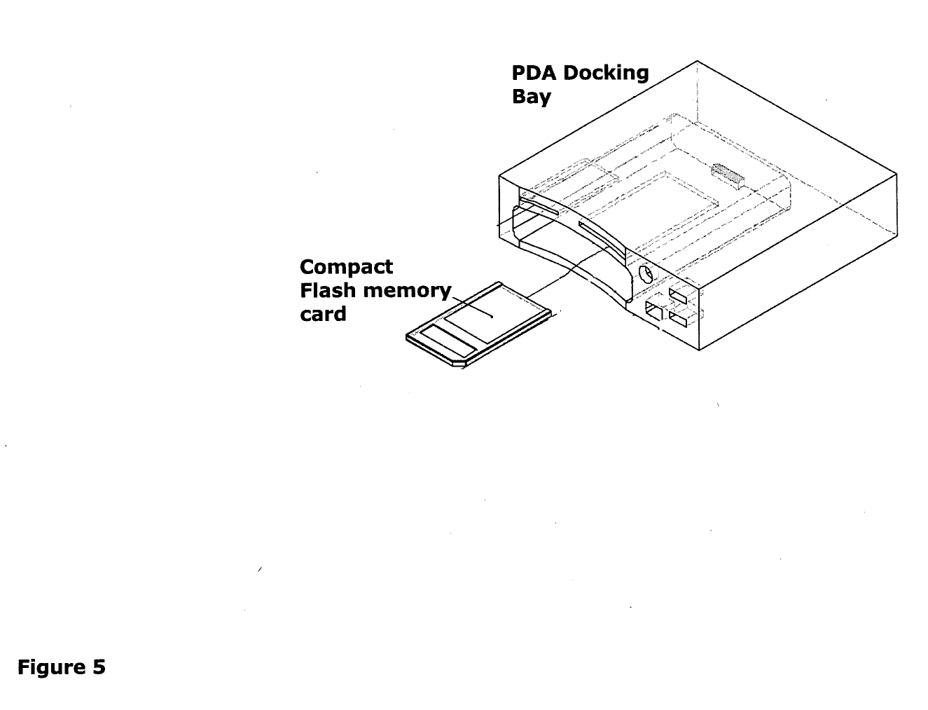

To operate the PDA docking modules integrated Compact Flash Memory Card Reader; insert the Compact Flash Memory Card into the designed slot (see FIG. 5). The host computer will detect the presence of the Compact Flash Memory Card.

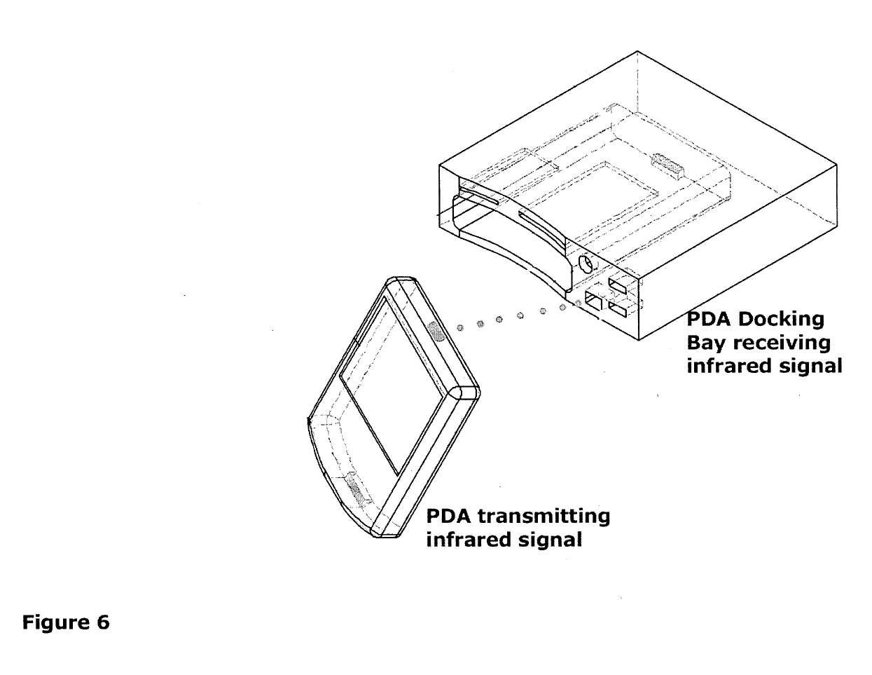

To operate the PDA docking modules integrated Infrared (IrDA) receiver, point the PDA at the IrDA module and manually activate the send feature of the PDA (see FIG. 6). The host computer will detect the presence of the incoming infrared transmission.

To remove the PDA, USB cable, Smart Media Card or Compact Flash Memory Card device from their respective ports, the individual device is simply pulled out.

1. A PDA docking bay module with peripheral integration consisting of a personal digital assistant (PDA) docking port to dock a PDA.

2. A PDA docking bay module with peripheral integration as recited in claim 1, wherein the docking bay module is configured to be mounted in the drive bay of a modular desktop computer.

3. A PDA docking bay module with peripheral integration as recited in claim 2, wherein the docking bay module is pre-configured to fit a modular desktop computer drive bay.

4. A PDA docking bay module with peripheral integration as recited in claim 1, where as the docking bay module is adapted with a Compact Flash (CF) memory card reader or CF memory card reader/writer.

5. A PDA docking bay module with peripheral integration as recited in claim 1, where as the docking bay module is adapted with a Smart Media (SM) memory card reader or SM memory card reader/writer.

6. A PDA docking bay module with peripheral integration as recited in claim 1, where as the docking bay module is adapted with one or more USB 2.0 ports.

7. A PDA docking bay module with peripheral integration as recited in claim 1, where as the docking bay module is adapted with an infrared (IrDA) enabled port.

8. A PDA docking bay module with peripheral integration as recited in claim 1, where as the docking bay module is adapted with a connector interface to facilitate data communication with the PDA and the host computer when the PDA is docked.

9. A PDA docking bay module with peripheral integration as recited in claim 1, where as the docking bay module supplies power to the PDA when the PDA is docked.

10. A PDA docking bay module with peripheral integration as recited in claim 1, where as the docking bay module supplies a charge to the PDA's rechargeable batteries when the PDA is docked.
